(19) United States
(12) Patent Application Publication
(10) Pub. No.: US 2026/0188558 A1
(43) Pub. Date: Jul. 2, 2026

(54) MAGNETIC COMPONENT

(71) Applicant: SAMSUNG ELECTRO-MECHANICS CO., LTD., Suwon-si (KR)

(72) Inventors: Ji Hye KIM, Suwon-si (KR); Sang Kyun KWON, Suwon-si (KR); Jong Ho CHUNG, Suwon-si (KR); Ji Man RYU, Suwon-si (KR); Ji Hoon HWANG, Suwon-si (KR); Chul Min SIM, Suwon-si (KR)

(73) Assignee: SAMSUNG ELECTRO-MECHANICS CO., LTD., Suwon-si (KR)

(21) Appl. No.: 19/392,351

(22) Filed: Nov. 18, 2025

(30) Foreign Application Priority Data
Dec. 27, 2024 (KR) 10-2024-0198117

(51) Int. Cl. H01F 27/255; H01F 1/03

(52) U.S. Cl. CPC H01F 27/255; H01F 1/0306

(57) ABSTRACT

A magnetic component includes a magnetic body. The magnetic body includes a plurality of magnetic particles including an Fe-based alloy. The Fe-based alloy includes a transition element including Fe in an amount of 76 mol % or more and 84 mol % or less, and P in an amount of 1 mol % or more and 6 mol % or less. In a particle size graph representing a relationship between diameters and the number of the plurality of magnetic particles, measured from an image of one cross-section of the magnetic body, when a difference between a D99 diameter and a D10 diameter is referred to as Dw, Dw is 15 μm or more and 30 μm or less. The particle size graph is a graph representing a relationship between diameters and the number of magnetic particles, among the plurality of magnetic particles, having a diameter of 3 μm or more.

### CROSS-REFERENCE TO RELATED APPLICATION(S)

This application claims benefit of priority to Korean Patent Application No. 10-2024-0198117 filed on Dec. 27, 2024 in the Korean Intellectual Property Office, the disclosure of which is incorporated herein by reference in its entirety.

### TECHNICAL FIELD

The present disclosure relates to a magnetic component.

With reductions in the size and thickness of electronic devices such as digital televisions, mobile phones, and notebook computers, reductions in size and thickness have also been required for magnetic components applied to such electronic devices. To meet such demands, various types of magnetic components have been used. As an example of a magnetic component, there is provided an inductor including a coil, and research and development of inductors of a winding type or a thin-film type have been actively conducted.

A major issue accompanying reductions in the size and thickness of magnetic components is achieving characteristics equivalent to those of components according to the related art despite such reductions in size and thickness. To satisfy such requirements, a proportion of magnetic material filled in a core may need to be increased. However, increasing the proportion of the magnetic material has limitations due to factors such as strength of the magnetic body and variations in frequency characteristics depending on insulating properties.

As an example of a method for manufacturing a magnetic component, a method of implementing a body by laminating a sheet obtained by mixing magnetic particles and a resin on a coil and then applying pressure thereto may be used. As the magnetic particles, ferrite, metal, or the like may be used. When metal magnetic particles are used, increasing a particle content may be advantageous in terms of permeability characteristics of the magnetic component. However, in this case, insulating properties of the magnetic body may degrade, resulting in eddy current loss.

### SUMMARY

An aspect of the present disclosure is to improve characteristics of a magnetic component using magnetic particles having an adjusted composition and particle size distribution of an Fe-based alloy.

According to an aspect of the present disclosure, there is provided a magnetic component including a magnetic body. The magnetic body may include a plurality of magnetic particles including an Fe-based alloy. The Fe-based alloy may include a transition element including Fe in an amount of 76 mol % or more and 84 mol % or less, and P in an amount of 1 mol % or more and 6 mol % or less. In a particle size graph representing a relationship between diameters of the plurality of magnetic particles and a number of magnetic particles, among the plurality of magnetic particles, having a diameter of 3 μm or more, when a difference between a D99 diameter and a D10 diameter is referred to as Dw, Dw may be 15 μm or more and 30 μm or less. The particle size graph may be obtained from an image of one cross-section of the magnetic body.

The D10 diameter may be 3 μm or more and 6 μm or less.

The D99 diameter may be 20 μm or more and 40 μm or less.

The particle size graph may have a plurality of peaks. The transition element may further include Co.

The transition element may include Co in an amount greater than 0 mol % and 30 mol % or less.

The Fe-based alloy may further include Si.

The Fe-based alloy may include Si in an amount greater than 0 mol % and 1 mol % or less.

The Fe-based alloy may further include B.

The Fe-based alloy may include B in an amount of 8 mol % or more and 15 mol % or less.

The Fe-based alloy may further include C.

The Fe-based alloy may include C in an amount of 0.5 mol % or more and 1.5 mol % or less.

The Fe-based alloy may further include Cu.

The Fe-based alloy may include Cu in an amount of 0.5 mol % or more and 1.5 mol % or less.

The plurality of magnetic particles may be amorphous, and the Fe-based alloy may further include Nb.

A magnetic component including magnetic particles according to an example of the present disclosure may have improved loss characteristics.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic transmission perspective view of a magnetic component according to an example embodiment of the present disclosure;

FIG. 2 is a cross-sectional view of a region of the magnetic component of FIG. 1;

FIG. 3 is an enlarged cross-sectional view of a region of the magnetic component of FIG. 1;

FIG. 4 is a particle size graph illustrating a relationship between a diameter, measured from an image of one cross-section of a magnetic body, and the number of particles having the diameter;

FIG. 5 is a schematic transmission perspective view of a magnetic component according to another example embodiment of the present disclosure; and

FIG. 6 is a schematic exploded perspective view of the magnetic component of FIG. 5.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

Various types of electronic components may be used in electronic devices, and various types of coil components may be appropriately used between such electronic components to remove noise. That is, in an electronic device, a coil component may be used as a power inductor, a high frequency (HF) inductor, a general bead, a high-frequency bead (GHz bead), a common mode filter, or the like.

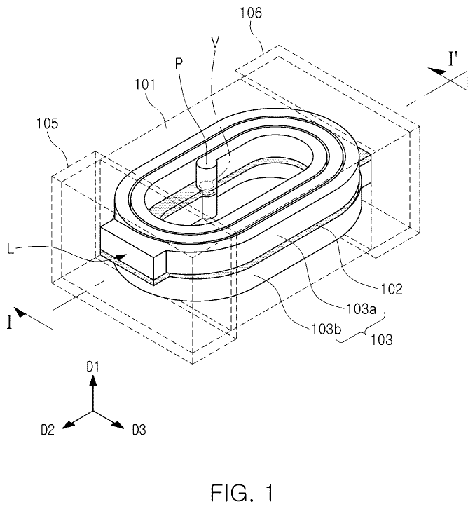

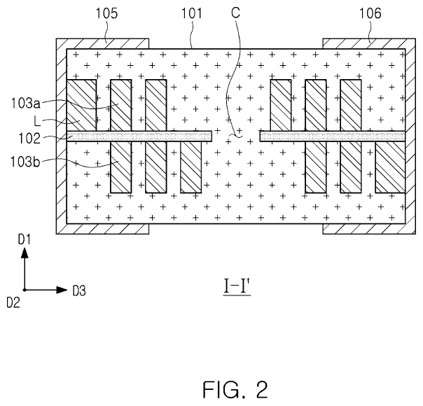

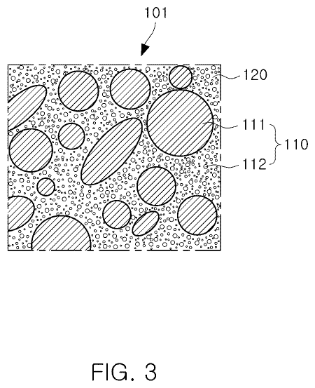

FIG. 1 is a schematic transmission perspective view of a magnetic component according to an example embodiment of the present disclosure. FIG. 2 is a cross-sectional view of a region of the magnetic component of FIG. 1. FIG. 3 is an enlarged cross-sectional view of a region of the magnetic component of FIG. 1.

Referring to FIGS. 1 to 3, a magnetic component 100 according to the present example embodiment may include a magnetic body 101 including a plurality of magnetic particles 110. Here, at least some magnetic particles 111, among the plurality of magnetic particles 110, may include an Fe-based alloy. The Fe-based alloy may include a transition element including Fe in an amount of 76 mol % or more and 84 mol % or less, and P in an amount of 1 mol % or more and 6 mol % or less. In addition, in a particle size graph representing a relationship between diameters and the number of the plurality of magnetic particles 111, measured from an image of one cross-section of the magnetic body 101, when a difference between a D99 diameter and a D10 diameter is defined as Dw, Dw may be 15 μm or more and 30 μm or less. Here, the particle size graph may represent a relationship between diameters and the number of magnetic particles, among the plurality of magnetic particles, having a diameter of 3 μm or more. When the composition and particle size conditions described above are satisfied, characteristics of the magnetic component 100, for example, eddy current loss may be reduced. When analyzing a size of the magnetic particle 111 based on cross-sectional area, a degree to which a small particle is reflected in data may be higher than that when analyzing a size of the magnetic particle 111 based on volume. In this case, eddy current loss characteristics, which are significantly influenced by particle size, may have a high correlation with particle size distribution. In consideration thereof, in the present example embodiment, in addition to specifying a content of the transition element, a content of P affecting formation of a small particle and a difference between the D99 diameter and the D10 diameter may be specified to reduce eddy current loss. Hereinafter, main components included in the magnetic component 100 according to the present example embodiment will be described.

The magnetic body 101 may form the exterior of the magnetic component 100. In the magnetic body 101, a coil 103 and a support member 102 supporting the coil 103 may be disposed. As illustrated in FIG. 3, the magnetic particles 111 may be dispersed in an insulating material 120. The insulating material 120 may include a dispersant, a binder, or the like and for example, may include a polymer component such as epoxy resin, polyimide, or the like. The magnetic body 101 may have an overall hexahedral shape. For example, the magnetic body 101 of the magnetic component 100 according to the present example embodiment, on which external electrodes 105 and 106 are formed, may have a length of 2.5 mm, a width of 2.0 mm, and a thickness of 1.0 mm, a length of 2.0 mm, a width of 1.2 mm, and a thickness of 0.65 mm, a length of 1.6 mm, a width of 0.8 mm, and a thickness of 0.8 mm, a length of 1.0 mm, a width of 0.5 mm, and a thickness of 0.5 mm, or a length of 0.8 mm, a width of 0.4 mm, and a thickness of 0.65 mm, but the present disclosure is not limited thereto. The above-described numerical values are merely design values not reflecting a process error or the like, such that it should be considered that dimensions within a range admitted as a processor error fall within the scope of the present disclosure.

A length of the magnetic component 100 in a first direction D1 may be measured based on an optical microscope or scanning electron microscope (SEM) image of a cross-section in the first direction D1-a third direction D3 of a central portion of the magnetic component 100 in a second direction D2. The length of the magnetic component 100 in the first direction D1 may refer to a maximum value among dimensions of a plurality of line segments respectively connecting two outermost boundary lines of the magnetic component 100, opposing each other in the first direction D1, illustrated in the cross-sectional image, the plurality of line segments being parallel to the first direction D1. Alternatively, the length of the magnetic component 100 in the first direction D1 may refer to a minimum value among the dimensions of the plurality of line segments.

Alternatively, the length of the magnetic component 100 in the first direction D1 may refer to an arithmetic mean value of at least three dimensions, among dimensions of the plurality of line segments. Here, the plurality of line segments, parallel to the first direction D1, may be spaced from each other at equal intervals in the third direction D3, but the present disclosure is not limited thereto.

A length of the magnetic component 100 in the second direction D2 may be measured based on an optical microscope image or an SEM image of a cross-section in the first direction D1-the second direction D2 of a central portion of the magnetic component 100 in the third direction D3. The length of the magnetic component 100 in the second direction D2 may refer to a maximum value among dimensions of a plurality of line segments respectively connecting two outermost boundary lines of the magnetic component 100, opposing each other in the second direction D2, as illustrated in the cross-sectional image, the plurality of line segments being parallel to the second direction D2. Alternatively, the length of the magnetic component 100 in the second direction D2 may refer to a minimum value among the dimensions of the plurality of line segments. Alternatively, the length may refer to an arithmetic mean value of at least three dimensions among the dimensions of the plurality of line segments. Here, the plurality of line segments parallel to the second direction D2 may be spaced from each other at equal intervals in the first direction D1, but the present disclosure is not limited thereto.

A length of the magnetic component 100 in the third direction D3 may be measured based on an optical microscope image or an SEM image of a cross-section in the first direction D1-the third direction D3 of a central portion of the magnetic component 100 in the second direction D2. The length of the magnetic component 100 in the third direction D3 may refer to a maximum value among dimensions of a plurality of line segments respectively connecting two outermost boundary lines of the magnetic component 100, opposing each other in the third direction D3, as illustrated in the cross-sectional image, the plurality of line segments being parallel to the third direction D3. Alternatively, the length of the magnetic component 100 in the third direction D3 may refer to a minimum value among the dimensions of the plurality of line segments. Alternatively, the length may refer to an arithmetic mean value of at least three dimensions among the dimensions of the plurality of line segments. Here, the plurality of line segments parallel to the third direction D3 may be spaced from each other in the first direction D1 at equal intervals, but the present disclosure is not limited thereto.

Each of the lengths of the magnetic component 100 in the first to third directions D1 to D3 may be measured using a micrometer measurement method. Each of the lengths of the magnetic component 100 may be measured by setting a zero point with a gage repeatability and reproducibility (R&R) micrometer, inserting the magnetic component 100 according to the present example embodiment into a space between tips of the micrometer, and turning a measurement lever of the micrometer. In measuring each of the lengths of the magnetic component 100 using the micrometer measurement method, each of the lengths of the magnetic component 100 may refer to an arithmetic mean of values measured a plurality of times.

With respect to an example of a manufacturing method, the magnetic body 101 may be formed by a method such as a lamination method or a winding method. When the lamination method, among the above-described methods, is used as an example, the coil 103 may be formed on the support member 102 using a method such as plating, and then a plurality of unit laminates for manufacturing the magnetic body 101 may be prepared and laminated. Here, the unit laminate may be manufactured in the form of a sheet by preparing a slurry in which the magnetic particles 110 are mixed with organic substances such as a thermosetting resin, a binder, and a solvent, coating the slurry on a carrier film using a doctor blade method to a thickness of several tens of micrometers (μm), and drying the coated slurry. Accordingly, the unit laminate may be manufactured such that the magnetic particles are dispersed in a thermosetting resin such as epoxy resin or polyimide. The unit laminate may be formed as a plurality of unit laminates, and the plurality of unit laminates may be pressure-laminated on an upper portion and a lower portion of the coil 103 to implement the magnetic body 101.

The support member 102 may support the coil 103, and may be formed of polypropylene glycol (PPG), ferrite, or a metal-based soft magnetic member. As illustrated, a central portion of the support member 102 may be penetrated to form a through-hole, and the through-hole may be filled with the magnetic body 101 to form a magnetic core portion C.

The coil 103 may be disposed in the magnetic body 101, and may perform various functions in an electronic device. For example, the magnetic component 100 may be a power inductor. In this case, the coil 103 may store electricity in the form of a magnetic field and serve to stabilize power by maintaining an output voltage. In this case, the coil 103 may be laminated on both surfaces of the support member 102, and the portions disposed on both surfaces of the support member 102 may be electrically connected to each other through a conductive via V passing through the support member 102. The coil 103 may have a spiral shape, and an outermost portion having a spiral shape may include a lead-out portion T, exposed to the outside of the magnetic body 101 for electrical connection with the external electrodes 105 and 106.

The coil 103 may be disposed on at least one of a first surface (an upper surface in FIG. 2) and a second surface (a lower surface in FIG. 2) of the support member 102, opposing each other. As in the present example embodiment, a first coil 103a and a second coil 103b may be respectively disposed on the first surface and the second surface of the support member 102. In this case, the coil 103 may include a pad P. However, alternatively, the coil 103 may only be disposed on one surface of the support member 102. A coil pattern included in the coil 103 may be formed using a method used in the art, for example, pattern plating, anisotropic plating, or isotropic plating, and a coil pattern having a multilayer structure may be formed using a plurality of processes, among the above-described processes.

The external electrodes 105 and 106 may be formed on the outside of the magnetic body 101 to be connected to the lead-out portion T. The external electrodes 105 and 106 may be formed using a conductive paste including a metal having excellent electrical conductivity. For example, the conductive paste may be a conductive paste including nickel (Ni), copper (Cu), tin (Sn), or silver (Ag) alone, or alloys thereof. In addition, a plating layer may be further formed on the external electrodes 105 and 106. In this case, the plating layer may include at least one selected from the group consisting of nickel (Ni), copper (Cu), and tin (Sn). For example, a nickel (Ni) layer and a tin (Sn) layer may be sequentially formed. In FIG. 1, the external electrodes 105 and 106 may have a shape extending from one side surface of the magnetic body 101 to an upper surface, a lower surface, and the other side surface of the magnetic body 101, but the external electrodes 105 and 106 may also be implemented in various other shapes, for example, in an L-shape.

In the present example embodiment, characteristics of the magnetic component 100 may be improved by adjusting a composition of the plurality of magnetic particles 111 included in the magnetic body 101 and a particle size distribution based on cross-sectional analysis. Referring to FIG. 3, as described above, the magnetic body 101 may include a plurality of magnetic particles 111 including an Fe-based alloy element. In addition, the magnetic body 101 may include second magnetic particles 112 having a relatively smaller diameter, and the second magnetic particles 112 may fill spaces between the magnetic particles 111 having a relatively larger diameter. In this case, the magnetic particles 111 may also be referred to as first magnetic particles 111 to distinguish from the second magnetic particles 112. A diameter for distinguishing the first magnetic particles 111 and the second magnetic particles 112 from each other may be, for example, 3 μm. That is, magnetic particles having a diameter of 3 μm or more may be classified as the first magnetic particles 111, and magnetic particles having a diameter of less than 3 μm may be classified as the second magnetic particles 112. The second magnetic particles 112 may have a composition different from that of the first magnetic particles 111, and may include, for example, pure iron. However, the second magnetic particles 112 may also include an Fe-based alloy element the same as that of the first magnetic particles 111. One or more insulating films may be formed on surfaces of the first and second magnetic particles 111 and 112. In addition to the first and second magnetic particles 111 and 112, magnetic particles having a smaller size, for example, third magnetic particles having a diameter of about 300 to 500 nm may further be included.

In the present example embodiment, the Fe-based alloy included in the magnetic particles 111 may include, as a compositional condition, a transition element including Fe in an amount of 76 mol % or more and 84 mol % or less, and P in an amount of 1 mol % or more and 6 mol % or less. In addition, as an additional compositional condition, the transition element in the Fe-based alloy may further include Co. In this case, when the total content of the transition element is referred to as 100 mol %, Co may be included in an amount greater than 0 mol % and 30 mol % or less. As in the present example embodiment, the Fe-based alloy may be formed to include the transition element including Fe in an amount of 76 mol % or more, thereby obtaining a high level of saturation magnetic flux density. However, when the transition element has a high content, amorphousness of the magnetic particles 111 may degrade, and thus an upper limit of the content of the transition element may be restricted to 84 mol %. In addition, the content of P may be controlled to increase a ratio of small particles advantageous for reducing eddy current loss. When P is included in an amount of 1 mol % or more and 6 mol % or less, the above-described particle size characteristics (Dw) and a low level of eddy current loss may be achieved.

In addition to the above-described compositional conditions, the Fe-based alloy may further include the following elements. First, the Fe-based alloy may further include Si. In this case, Si may be included in an amount greater than 0 mol % and 1 mol % or less. The Fe-based alloy may further include B. In this case, B may be included in an amount of 8 mol % or more and 15 mol % or less. The Fe-based alloy may further include C. In this case, C may be included in an amount of 0.5 mol % or more and 1.5 mol % or less. The Fe-based alloy may further include Cu. In this case, Cu may be included in an amount of 0.5 mol % or more and 1.5 mol % or less. The amount of each element in the Fe-based alloy is based on a total amount of all elements in the Fe-based alloy.

Analysis of elements included in the Fe-based alloy and contents of the respective elements may be performed through the following process. For example, analysis may be performed through the following process. First, as a method of analyzing a composition of the magnetic particles 111, an electron probe micro analyzer (EPMA) method may be used. When a cross-section of the magnetic component 100 is polished, and then an electron beam accelerated to about 15 kV to about 30 kV from an electron gun is irradiated onto surfaces of the magnetic particles 111, X-rays having specific wavelengths (energies) for respective elements of the magnetic particles 111 may be generated, and a chemical composition may be identified by detecting the X-rays using a detector. In this case, a region analyzed by EPMA may be a local region of the magnetic particles 111, such that analysis may be performed on a plurality of measurement points (for example, five or more measurement points) at equal intervals on the surfaces of the magnetic particles 111, and an average value thereof may be used. As another analysis method, an inductively coupled plasma (ICP) method may be used. After polymer elements are removed from an electronic component using a liquid capable of decomposing the polymer elements, a coil may be physically removed. Thereafter, the remaining magnetic particles 111 may be dissolved in an acidic solution, and elements thereof may be analyzed using an inductively coupled plasma-atomic emission spectrometer (ICP-AES). In addition, transmission electron microscopy with energy dispersive spectroscopy (TEM-EDS) analysis or scanning electron microscopy with energy dispersive spectroscopy (SEM-EDS) analysis may be used. The above-described analysis methods may be performed using a cross-section of the magnetic component 100 in FIG. 2. For example, a composition of the Fe-based alloy included in the magnetic particles 111 may be obtained from an image of a cross-section in the first direction-third direction D1-D3 obtained by cutting an intermediate portion of the magnetic body 101 in the second direction D2, and may be an average value for the plurality of magnetic particles 111. In addition, the above-described analysis process may be performed on a plurality of cross-sections of the magnetic body 101, for example, on a plurality of cross-sections (for example, five or more cross-sections) in the first direction-third direction D1-D3 spaced apart from each other at equal intervals in opposite directions from the intermediate portion of the magnetic body 101 in the second direction D2, and an average value may be calculated. Other methods and/or tools appreciated by one of ordinary skill in the art, even if not described in the present disclosure, may also be used.

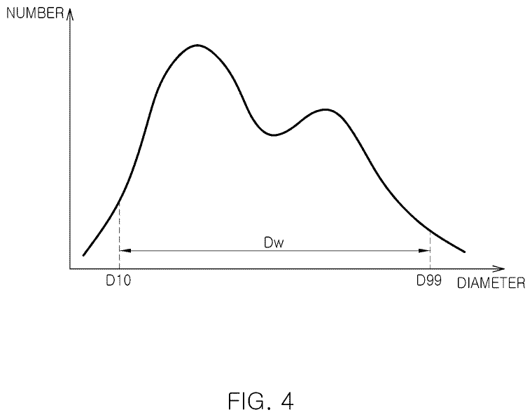

In addition to the compositional conditions of the Fe-based alloy, in the present example embodiment, a particle size distribution of the plurality of magnetic particles 111 may be adjusted. FIG. 4 is a particle size graph representing a relationship between a diameter, measured from an image of one cross-section of a magnetic body, and the number of particles having the diameter. Here, the particle size graph may be represented in a linear scale or a logarithmic scale.

In this case, a diameter of each of the plurality of magnetic particles 111 may be obtained from an image (e.g., a micrograph) of one cross-section of the magnetic body 101, for example, a cross-section in the first direction-third direction D1-D3 obtained by cutting an intermediate portion of the magnetic body 101 in the second direction D2 in FIG. 2, and may be an average value for the plurality of magnetic particles 111. In addition, the diameter of each of the plurality of magnetic particles 111 may be a major axis length of each of the magnetic particles 111. However, in some cases, the diameter of each of the plurality of magnetic particles 111 may be obtained by calculating an area of each of the magnetic particles 111 in a cross-section of the magnetic body 101 and converting the area into an equivalent circular diameter. In this case, the magnetic particles 111 in an outer region of the magnetic body 101 may be deformed by a pressing process or the like. Accordingly, a region within a length corresponding to 5% or 10% from the surface of the magnetic body 101 may be excluded from the diameter measurement. The diameter of each of the plurality of magnetic particles 111 may not be obtained only from a single cross-section of the magnetic body 101, but may be calculated by averaging a plurality of values obtained from a plurality of cross-sections. Here, the plurality of cross-sections of the magnetic body 101 may be, for example, five or more cross-sections spaced apart from each other in the first direction-third direction D1-D3 at equal intervals in opposite directions from the intermediate portion of the magnetic body 101 in the second direction D2. Other methods and/or tools appreciated by one of ordinary skill in the art, even if not described in the present disclosure, may also be used.

In the present example embodiment, in a particle size graph of FIG. 4 representing a relationship between diameters and the number of the plurality of magnetic particles 111, measured from an image of one cross-section of the magnetic body 101, Dw, which is the difference between the D99 diameter and the D10 diameter, may be 15 μm or more and 30 μm or less. The D10 and D99 diameters may represent diameters respectively corresponding to 10% and 99% of the total accumulated number of particles after accumulating the number of particles corresponding to each diameter. In this case, the particle size graph may have a plurality of peaks. Even when a single peak appears in a volume-based particle size distribution, a plurality of peaks may appear in a cross-section-based particle size graph. As described above, when analyzing sizes of magnetic particles 111 based on cross-section area, a degree to which a small particle is reflected in data may be higher than that when analyzing the sizes of magnetic particles 111 based on volume. This may be because one particle is reflected as one in the number. Accordingly, it was found that the particle size distribution based on cross-sectional analysis has a high correlation with the eddy current loss characteristics, significantly influenced by particle size. Particularly, Dw and the eddy current loss characteristics had a high correlation therebetween. In addition, a Dw value may be restricted to be within a specific range, such that the magnetic particles 111 may have a more uniform size. As a result, a packing ratio of the magnetic particles 111 in the magnetic body 101 may be improved. In some embodiments, D10 and D99 represent the diameter below which 10% and 99%, respectively, of the particles are found in the particle size graph.

In terms of a high proportion of small particles and uniformity in particle size, in addition to the Dw value, the D10 and D99 diameters may also be specified. Specifically, in the particle size graph of FIG. 4, the D10 diameter may be 3 μm or more and 6 μm or less. In addition, the D99 diameter may be 20 μm or more and 40 μm or less. The particle size graph of FIG. 4 may be based on magnetic particles 111, among the plurality of magnetic particles 110 of FIG. 3, having a relatively large diameter, and specifically, may be a graph representing a relationship between diameters and the number of magnetic particles 111, among the plurality of magnetic particles 110, having a diameter of 3 μm or more. In this case, particles having a relatively small diameter of less than 3 μm may be defined as second magnetic particles 112.

The inventors of the present disclosure prepared samples of magnetic particles having different compositions and particle size distributions of Fe-based alloys, and analyzed amorphousness and eddy current loss characteristics of the magnetic particles. Here, a particle size distribution of the magnetic particles may be influenced by a composition of a Fe-based alloy, particularly a content of P. Table 1 below shows compositional conditions of the samples, and a content of each element may be represented in mol %. A content of Co may be represented as a mol % based on the entire Fe-based alloy. A mol % within a transition element may be converted into a mol % based on the total content of another transition element such as Fe. Table 2 shows the amorphousness, eddy current loss (based on 1 MHz), D10 diameter, D99 diameter, and Dw.

TABLE 1

| | Fe | Co | Si | B | P | C | Cu | Nb |
|---|---|---|---|---|---|---|---|---|
| #1* | 79 | 0 | 5.7 | 13.3 | 0 | 2 | 0 | 0 |
| #2* | 72 | 0 | 13.5 | 2 | 8 | 0 | 1.5 | 3 |
| #3* | 58.3 | 26 | 5.7 | 10 | 0 | 0 | 0 | 0 |
| #4 | 72 | 8 | 0 | 13 | 5 | 1 | 0.5 | 0.5 |
| #5 | 71.5 | 10 | 0 | 12 | 5 | 0.5 | 0.5 | 0.5 |
| #6 | 70 | 13 | 0 | 13 | 5 | 0.5 | 0.5 | 0.5 |
| #7 | 60.5 | 20 | 0 | 13 | 4 | 0.5 | 1 | 1 |
| #8 | 76 | 0 | 6 | 13 | 3 | 0.5 | 0.5 | 1 |
| #9 | 69 | 10 | 1 | 13 | 2 | 2 | 1 | 2 |
| #10 | 62 | 16 | 2 | 13.5 | 2 | 1.4 | 0.6 | 2.5 |
| #11 | 76 | 8 | 1 | 13 | 1 | 0 | 0.6 | 0.4 |
| #12 | 63.5 | 19 | 0.5 | 11 | 5 | 0 | 0.6 | 0.4 |
| #13 | 79 | 5 | 0.5 | 9 | 6 | 0 | 0.5 | 0 |

TABLE 2

| | | D10 | D99 | Dw | Eddy current |
|---|---|---|---|---|---|
| | Amorphousness | (μm) | (μm) | (μm) | loss (mW/cc) |
| #1* | Amorphous | 5.32 | 35.1 | 29.78 | 319 |
| #2* | Amorphous | 6.44 | 34.69 | 28.25 | 306 |
| #3* | Amorphous | 4.52 | 24.39 | 19.87 | 133 |
| #4 | Amorphous | 5.31 | 32.24 | 26.93 | 201 |
| #5 | Amorphous | 4.59 | 28.37 | 23.78 | 123 |
| #6 | Amorphous | 3.75 | 21.68 | 17.93 | 68 |
| #7 | Amorphous | 3.79 | 21.71 | 17.92 | 53 |
| #8 | Amorphous | 5.42 | 32.92 | 27.5 | 224 |
| #9 | Amorphous | 5.35 | 34.52 | 29.17 | 262 |
| #10 | Amorphous | 3.9 | 22.66 | 18.76 | 66 |
| #11 | Amorphous | 3.96 | 21.8 | 17.84 | 78 |
| #12 | Amorphous | 3.93 | 22.11 | 18.18 | 51 |
| #13 | Amorphous | 5.27 | 30.95 | 25.68 | 210 |

In the above experimental example, #1 to #3 marked with * are comparative examples, and the remaining #4 to #13 are example embodiments. According to the experimental results, when the compositional conditions and Dw conditions proposed in the example embodiments of the present disclosure are satisfied, it may be confirmed that eddy current loss tends to be relatively low. In this case, eddy current loss may tend to increase as the Dw value increases, and thus a reference thereof may vary depending on the Dw value. Specifically, when Dw is 15 μm or more and 20 μm or less, eddy current loss may be in a range of 50 to 100 mW/cc at 1 MHz. When Dw is 20 μm or more and 25 μm or less, eddy current loss may be in a range of 100 to 200 mW/cc at 1 MHz. When Dw is 25 μm or more and 30 μm, eddy current loss may be in a range of 150 to 300 mW/cc at 1 MHz. In this case, the intended effect was exhibited.

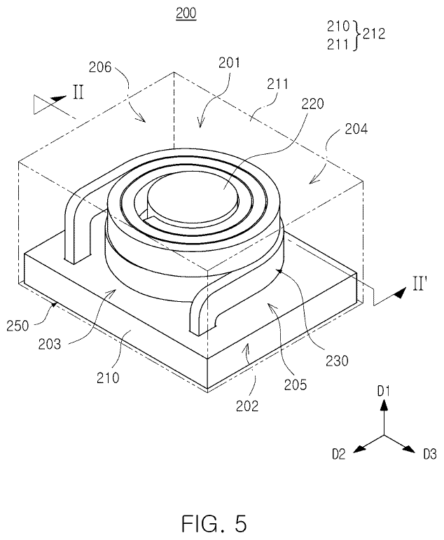

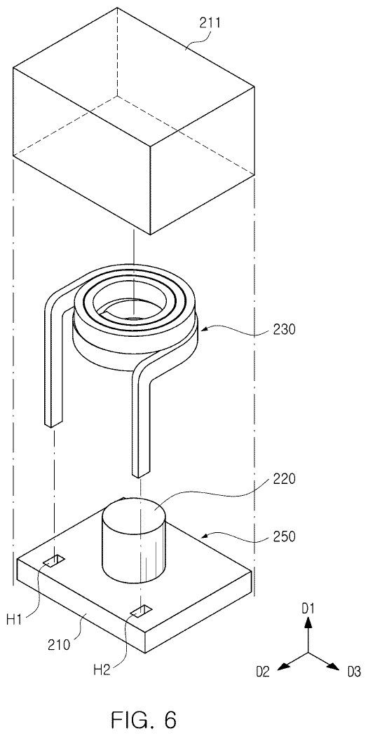

Referring to FIGS. 5 and 6, another example embodiment of the present disclosure will be described. In the previous example embodiment, a coil 103 and a support member 102, supporting the coil, may be disposed in a magnetic body 101. Conversely, In the example embodiment of FIGS. 5 and 6, a wound-type coil may be used. Specifically, a magnetic component 200 may include a molded portion 250, a coil 230, and a cover portion 211. The magnetic body 212 may form the exterior of the magnetic component 200, and the coil 230 may be buried in the magnetic body 212. The magnetic body 212 may include the molded portion 250 and the cover portion 260. The molded portion 250 may include a core 220. The magnetic body 212 may have an overall hexahedral shape. The magnetic body 212 may include a first surface 201 and a second surface 202 opposing each other in a first direction D1, a third surface 203 and a fourth surface 204 opposing each other in a second direction D2, and a fifth surface 205 and a sixth surface 206 opposing each other in a third direction D3. Each of the third to sixth surfaces 203-206 may correspond to a wall surface of the magnetic body 212 connecting the first surface 201 and the second surface 202 to each other.

The magnetic body 212 may be implemented in the same manner as the previous example embodiment. The magnetic body 212 may be formed such that the magnetic component 200 has a length of 2.0 mm, a width of 1.2 mm, and a thickness of 0.6 mm, but the present disclosure is not limited thereto. The magnetic body 212 may include the molded portion 250 and the cover portion 260. The cover portion 260 may be disposed on an upper portion of the molded portion 250 to surround all surfaces except for a lower surface of the molded portion 250. The molded portion 250 may have one surface and the other surface opposing each other. The one surface of the molded portion 250 may correspond to the lower surface of the molded portion 250, and may have an accommodation groove for accommodating both ends of the coil 230. The molded portion 250 may include a support portion 210 and a core 220. The core 220 may be formed to pass through the coil 230, and may be disposed on a central portion of the other surface of the support portion 210. The molded portion 250 may be formed by filling a composite material including the magnetic particles 111 and an insulating resin into a mold. The insulating resin may include, alone or in combination, epoxy, polyimide, a liquid crystal polymer (LCP), but the present disclosure is not limited thereto.

The coil 230 may be buried in the magnetic body 212 to exhibit characteristics of the magnetic component 200. For example, when the magnetic component 200 according to the present example embodiment is used as a power inductor, the coil 230 may serve to stabilize power of an electronic device by storing an electric field as a magnetic field and maintaining an output voltage. The coil 230 may be disposed on the other surface of the molded portion 250. Specifically, the coil 230 may be wound around the core 220, and disposed on the other surface of the support portion 210. The coil 230 may be an air-core coil, and may be formed as a rectangular coil. The coil 230 may be formed by winding a metal wire such as a copper wire coated with an insulating material in a spiral shape. The coil 230 may include a plurality of layers. Each of the layers of the coil may have a planar spiral shape, and thus may have a plurality of turns.

The cover portion 260 may be disposed on the molded portion 250 and the coil 230. The cover portion 260 may cover the molded portion 250 and the coil 230. The cover portion 260 may be disposed on the support portion 210 of the molded portion 250, the core 220, and the coil 230, and may be pressed and bonded to the molded portion 250. The molded portion 250 and the cover portion 260 may respectively include magnetic particles 110, and the magnetic particles 110 may include first magnetic particles 111 and second magnetic particles 112 formed on a surface thereof, as described above.

The magnetic body 212 may be a region including the molded portion 250 and the cover portion 260, and thus one surface of the magnetic body 212 may refer to one surface of the region including the molded portion 250 and the cover portion 260. The coil 230 may include first and second lead-out portions, which are led out to the outside and disposed on the lower surface of the molded portion 250.

For example, through-grooves H1 and H2 may be formed by a mold when the molded portion 250 is formed. A mold for forming the molded portion 250 may include protrusions corresponding to the through-grooves H1 and H2, such that the through-grooves H1 and H2 may be formed in the molded portion 250 manufactured in a shape corresponding to a shape of the mold. In addition, both ends of the coil portion 300, which is protrudingly disposed on the one surface of the molded portion 250 through the through-grooves H1 and H2 of the molded portion 250, may be buried in the molded portion 250 in a magnetic sheet pressing process. As a result, an accommodation groove may be formed in the one surface of the molded portion 250.

Both ends of the coil 230 may respectively pass through the one surface of the molded portion 250, and may be disposed on the lower surface of the molded portion 250, for example, in the accommodation groove of the molded portion 250. Both ends of the coil 230 may be exposed to one surface of the molded portion 250, that is, a second surface 202 of the magnetic body 212.

The magnetic component 200 according to the present example embodiment may further include an insulating layer 290 surrounding a surface of the coil 230. A method of forming the insulating layer 290 is not limited, but may be formed, for example, by chemical vapor deposition of a parylene resin or the like on the surface of the coil 230, and may be formed by a known method such as a screen printing method, a process through exposure and development of a photoresist (PR), a spray coating process, a dipping process, or the like. The insulating layer 290 is not limited as long as it is formed as a thin film, and may be formed to include, for example, a photoresist (PR), an epoxy-based resin, or the like.

While example embodiments have been shown and described above, it will be apparent to those skilled in the art that modifications and variations could be made without departing from the scope of the present disclosure as defined by the appended claims.

What is claimed is:

1. A magnetic component comprising:
a magnetic body,
wherein the magnetic body includes a plurality of magnetic particles including an Fe-based alloy,
the Fe-based alloy includes:
a transition element including Fe in an amount of 76 mol % or more and 84 mol % or less, and
P in an amount of 1 mol % or more and 6 mol % or less,
in a particle size graph representing a relationship between diameters of the plurality of magnetic particles and a number of magnetic particles, among the plurality of magnetic particles, having a diameter of 3 μm or more, when a difference between a D99 diameter and a D10 diameter is referred to as Dw, Dw is 15 μm or more and 30 μm or less, and
the particle size graph is obtained from an image of one cross-section of the magnetic body.

2. The magnetic component of claim 1, wherein the D10 diameter is 3 μm or more and 6 μm or less.

3. The magnetic component of claim 1, wherein the D99 diameter is 20 μm or more and 40 μm or less.

4. The magnetic component of claim 1, wherein the particle size graph has a plurality of peaks.

5. The magnetic component of claim 1, wherein the transition element further includes Co.

6. The magnetic component of claim 5, wherein the transition element includes Co in an amount greater than 0 mol % and 30 mol % or less.

7. The magnetic component of claim 1, wherein the Fe-based alloy further includes Si.

8. The magnetic component of claim 7, wherein the Fe-based alloy includes Si in an amount greater than 0 mol % and 1 mol % or less.

9. The magnetic component of claim 1, wherein the Fe-based alloy further includes B.

10. The magnetic component of claim 9, wherein the Fe-based alloy includes B in an amount of 8 mol % or more and 15 mol % or less.

11. The magnetic component of claim 1, wherein the Fe-based alloy further includes C.

12. The magnetic component of claim 11, wherein the Fe-based alloy includes C in an amount of 0.5 mol % or more and 1.5 mol % or less.

13. The magnetic component of claim 1, wherein the Fe-based alloy further includes Cu.

14. The magnetic component of claim 13, wherein the Fe-based alloy includes Cu in an amount of 0.5 mol % or more and 1.5 mol % or less.

15. The magnetic component of claim 1, wherein the plurality of magnetic particles are amorphous, and the Fe-based alloy further includes Nb.
